(19) United States
(12) Patent Application Publication
(10) Pub. No.: US 2006/0261796 A1
(43) Pub. Date: Nov. 23, 2006

(54) Apparatus and method for generating variable constant voltage

(75) Inventors: Ji Man Park, Daejeon-city (KR); Young Soo Park, Daejeon-city (KR); Sung Ik Jun, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/437,103

(22) Filed: May 19, 2006

(30) Foreign Application Priority Data
May 20, 2005 (KR) 10-2005-0042424

(51) Int. Cl. G05F 3/04

(52) U.S. Cl. 323/312

(57) ABSTRACT

Provided are a variable constant voltage generator generating a plurality of constant voltages, and more particularly, to a variable constant voltage generator which varies a reference voltage by changing a resistance value through on/off switching, thereby converting an output voltage into a plurality of constant voltages. The apparatus for generating a variable constant voltage, the apparatus includes: a reference voltage controller controlling on/off switches connected to ends of N resistors according to a digital signal value; a variable reference voltage generator generating a reference voltage corresponding to a resistance value obtained by controlling the on/off switches; and a regulator generating a constant voltage based on the reference voltage and an external input voltage.

### BACKGROUND OF THE INVENTION

This application claims the benefit of Korean Patent Application No. 10-2005-0042424, filed on May 20, 2005, and in the Korean Intellectual Property Office, the disclosure of which is incorporated herein in its entirety by reference.

1. Field of the Invention

The present invention relates to a variable constant voltage generator generating a plurality of constant voltages, and more particularly, to a variable constant voltage generator which varies a reference voltage by changing a resistance value through on/off switching, thereby converting an output voltage into a plurality of constant voltages.

2. Description of the Related Art

Conventional constant voltage generators supply a direct current voltage with a stable single value as required by systems such as circuits or semiconductor chips. In detail, conventional constant voltage generators receive an unclean direct current voltage and a plurality of direct current voltages as input voltages, and generate the direct current voltage received from input voltages.

However, when conventional constant voltage generators always supply a uniform single direct current voltage to chips or systems, a variation in power consumption due to operations of chips or systems, data processing in chips can be sensed. Accordingly, while the single direct current voltage is supplied to systems such as smart cards or security chips, an attacker may attempt to hack systems by measuring the power change resulting from an internal operation and data processing and extract statistical data.

Thus, smart cards or security chips that operate using a single direct current voltage are exposed to a power attack at all times.

Also, since a single direct current voltage is continuously supplied to conventional power management systems, systems cannot supply a greater direct current voltage when they must perform a quick process, requiring more power than the normal input power. Instead, since the single direct current voltage is supplied to the systems in a pause state, systems consume unnecessary power.

### SUMMARY OF THE INVENTION

The present invention provides an apparatus and method for generating a variable constant voltage in order to prevent a power attack and effectively manage power.

According to an aspect of the present invention, there is provided an apparatus for generating a variable constant voltage, the apparatus comprising: a reference voltage controller controlling on/off switches connected to ends of N resistors according to a digital signal value; a variable reference voltage generator generating a reference voltage corresponding to a resistance value obtained by controlling the on/off switches; and a regulator generating a constant voltage based on the reference voltage and an external input voltage.

According to another aspect of the present invention, there is provided a method of generating a variable constant voltage, the method comprising: generating a resistance value by controlling on/off switches connected to each end of N resistors according to a digital signal value; generating a reference voltage corresponding to the resistance value; and generating a constant voltage based on the reference voltage and an external input voltage.

According to still another aspect of the present invention, there is provided a system comprising: a first data processor storing, calculating, and inputting/outputting data to produce a power consumption waveform corresponding to data processing for a stable system power source; a second data processor encoding data to prevent the system against hacking; a fixed constant voltage generator providing the first data processor with a fixed constant voltage; and a variable constant voltage generator controlling on/off switches connected to ends of N resistors according to a digital signal value to produce a random or constant power consumption waveform, generating a reference voltage corresponding to the resistance value, generating a constant voltage based on the reference voltage and an external input voltage, and providing the constant voltage to the second data processor.

### BRIEF DESCRIPTION OF THE DRAWINGS

The above and other features and advantages of the present invention will become more apparent by describing in detail exemplary embodiments thereof with reference to the attached drawings in which:

FIG. 1A is a block diagram of an apparatus for generating a variable constant voltage according to an embodiment of the present invention;

FIG. 1B is a detailed block diagram of the apparatus for generating the variable constant voltage according to an embodiment of the present invention;

FIG. 2 is a circuit diagram of an apparatus for generating a variable constant voltage according to an embodiment of the present invention;

FIGS. 3A through 3D are graphs illustrating power consumption by a security chip;

FIG. 4 is a block diagram of a chip or a system including an apparatus for generating a variable constant voltage;

FIG. 5 is a perspective view of a variable constant voltage generator connected to a fixed constant voltage generator;

FIG. 6 is a block diagram of a chip or a system including a fixed constant voltage generator and a variable constant voltage generator; and

FIG. 7 is a flowchart of a method of generating a variable constant voltage according to an embodiment of the present invention.

### DETAILED DESCRIPTION OF THE INVENTION

Hereinafter, exemplary embodiments of the present invention will be described in detail with reference to the attached drawings.

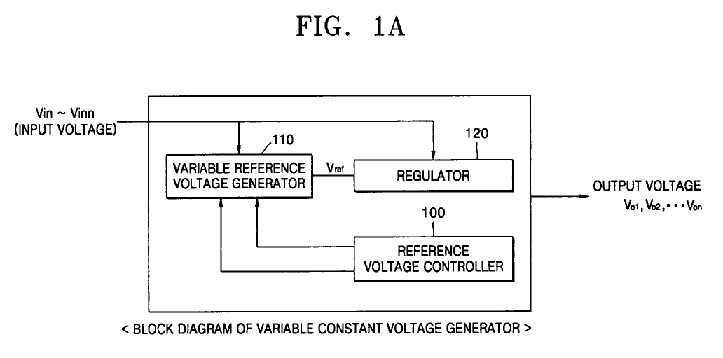

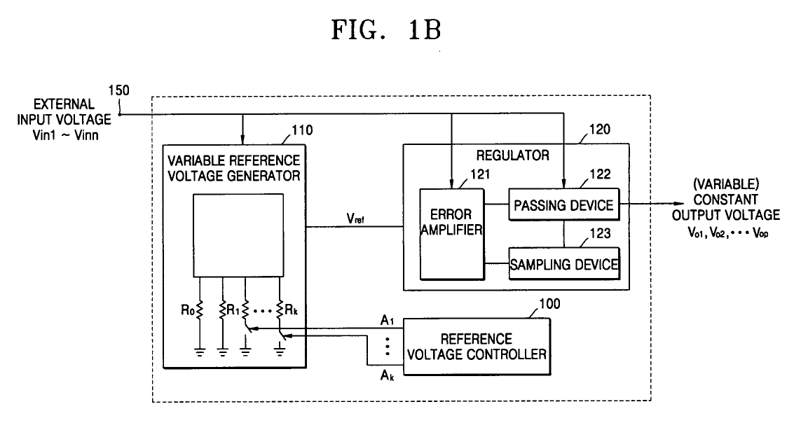

FIGS. 1A and 1B are a block diagrams of an apparatus for generating a variable constant voltage according to an embodiment of the present invention. Referring to FIGS. 1A and 1B, the apparatus for generating the variable constant voltage comprises a reference voltage controller 100, a variable reference voltage generator 110, and a regulator 120.

The reference voltage controller 100 generates digital signals having values 1 and 0 to control on/off switches connected to ends of at least one resistors R1, R2, . . . Rn. The reference voltage controller 100 determines a resistance value Rd by controlling the on/off switches.

The variable reference voltage generator 110 generates a reference voltage Vref corresponding to the resistance value Rd obtained by the reference voltage controller 100. The reference voltage Vref is changed into a plurality of reference constant voltage values according to changes in the resistance value Rd by the reference voltage controller 100.

The regulator 120 comprises an error amplifier 121, a passing device 122, and a sampling device 123 and generates a constant voltage Vout from the reference voltage Vref generated by the variable reference voltage generator 110 and an external input voltage Vin.

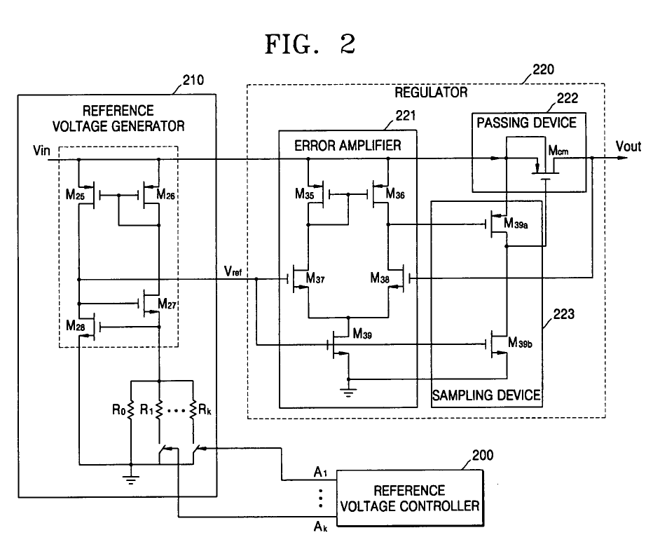

FIG. 2 is a circuit diagram of an apparatus for generating a variable constant voltage according to an embodiment of the present invention. Referring to FIG. 2, a reference voltage controller 200 generates a plurality of digital signals that control on/off switches using a CPU and a software program, a hardware-based random number generator, an irregular signal device, or a combination of software and hardware.

The reference voltage controller 200 controls the on/off switches according to a voltage value required by a system or a chip from the apparatus for generating a variable constant voltage. The digital signals output by the reference voltage controller 200 have a value 1 or 0 and control whether resistors R1, R2, . . . Rn are grounded by opening and closing the on/off switches according to the digital signal.

A reference voltage generator 210 produces a resistance value Rd obtained by the on/off switches controlled by the reference voltage controller 200, and MOS transistors M25 through M28. The reference voltage generator 210 returns an input voltage Vin from source terminals of the MOS transistors M25 and M26 using the MOS transistors M27 and M28 and the resistance value Rd, and simultaneously maintains a constant drain voltage of the MOS transistor M28 to generate a reference voltage Vref. Therefore, the reference voltage Vref is not changed by a change in the input voltage Vin but by a change in the combination of the on/off switches turned on and off by the reference voltage controller 200.

A regulator 220 receives the reference voltage Vref generated by the reference voltage generator 210 and an input voltage Vin to generate a constant voltage Vout. The constant voltage Vout has values Vo₁, Vo₂, . . . Voₚ according to changes in the reference voltage Vref.

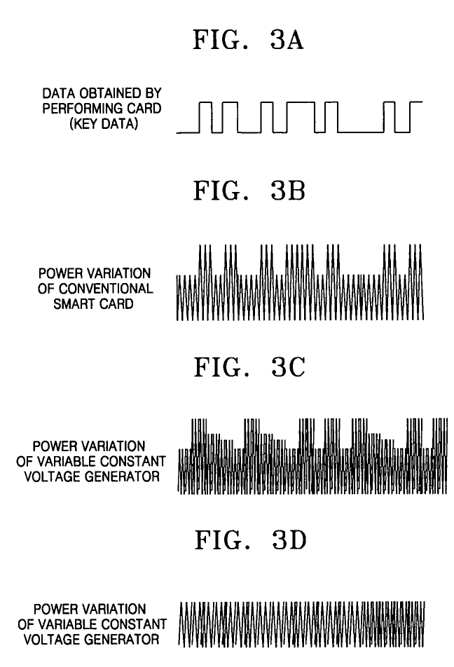

FIGS. 3A through 3D illustrate waveforms of power variations of the apparatus for generating the variable constant voltage according to an embodiment of the present invention.

FIG. 3A illustrates a waveform of key data obtained by performing a card.

FIG. 3B illustrates a waveform of power consumption of a conventional smart card or security chip. Referring to FIG. 3B, since the conventional smart card or security chip supplies a single constant voltage, statistical data regarding power variations resulting from the execution of a command or an operation (refer to FIG. 3A) by the device can be obtained. The device such as the smart card or the security chip perceives variations in power according to the execution command of the device, which may allow hacking via a power attack.

Therefore, the device such as the smart card or the security chip requires security stability against the hacking by the power attack. For security protection, the apparatus for generating the variable constant voltage according to an embodiment of the present invention changes an output voltage for operating the system such as the smart card or the security chip into an internal power module or a single chip, thereby protecting the smart card or the security chip from the hacking.

FIGS. 3C and 3D illustrate waveforms of power consumption that is not related to the execution command (refer to the key data waveform illustrated in FIG. 3A). An attacker cannot identify whether the waveforms illustrated in FIGS. 3C and 3D are power consumption signal waveforms produced by operation data or power consumption waveforms produced by controlling a power module, such that statistical data cannot be obtained through the conventional hacking by a power attack, i.e., variations in power consumption.

To produce a random power consumption waveform illustrated in FIG. 3C, the reference voltage controller 200 realized by one of software, hardware, and a combination of software and hardware to control the on/off switches generates a random digital signal variation.

The random digital signal generated by the reference voltage controller 200 controls resistance switching, thereby randomly performing the resistance switching. Therefore, the variable reference voltage generator 210 generates a random reference voltage Vref_r according to a random resistance value Rd_r obtained by the random resistance switching.

To protect against the hacking by a power attack using the waveform as illustrated in FIG. 3D, maximum and minimum values of a consumption power amplitude are maintained constant, and switching is controlled to produce a regular waveform within the minimum and maximum consumption power amplitudes, thereby preventing an attacker from analyzing power consumption.

To this end, when a greater power consumption is measured in an external input voltage generator than is required according to the operation of a memory, input/output interface, system logic, CPU, etc. of a security chip, smart card, or other system, i.e., when the power consumption of the system increases as a current supply increases while the voltage supply remains unchanged, the reference voltage controller 200 perceives the increase in consumption power using an internal module and decreases the reference voltage Vref, thereby reducing the power consumption.

Also, when a smaller power consumption is measured in an external input voltage generator than is required according to the operations of a memory, input/output interface, system logic, CPU, etc. of security chip, smart card, or other systems, i.e., when the power consumption of the system decreases as the current supply decreases while the voltage supply remains unchanged, the reference voltage controller 200 perceives the decrease in the power consumption using the internal module and increases the reference voltage Vref, thereby producing a regular waveform of the power consumption.

The controlling process performed by the reference voltage controller 200 results in the waveform of the power consumption illustrated in FIG. 3D, and the attacker cannot obtain the data required to determine the operation of the system, thereby protecting the system from hacking.

More specifically, assuming that a smart card requires 3 bias voltages, and the reference voltage controllers 100 and 200 generate the variable output voltage Vout at 2.8V, 3V, and 3.2V.

Referring to FIG. 3C, when the smart card carries out an execution command, the reference voltage controller 100 or 200 generates a random digital signal to make the reference voltage generator 110 or 210 generate a random reference voltage Vref_r, and generate a random output voltage Vout_r, such that it is impossible to perceive whether the consumption power variation is caused by the execution command or the variation in the output voltage Vout.

Referring to FIG. 3D, the reference voltage controller 200 is coupled with the execution command performed by the smart card to change the reference voltage Vref and the output voltage Vout, thereby producing a seemingly regular waveform for the power consumption.

2.8 volts are applied for a command requiring large power consumption and 3.2 volts are applied to a command requiring small power consumption, thereby maintaining a constant waveform for the power consumption according to the execution command performed by the smart card.

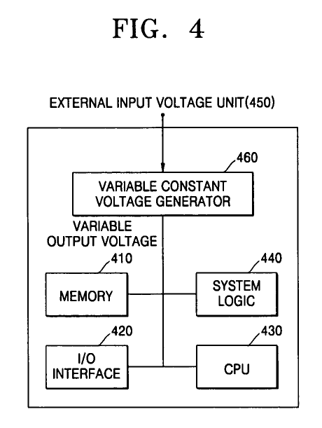

FIG. 4 is a block diagram of a chip or a system including an apparatus for generating a variable constant voltage. Referring to FIG. 4, power source such as an external chip, i.e., power source used to operate a smart card, a security chip, etc., is a constant voltage source. The constant voltage source can be embedded in the external chip, or a constant voltage generator embedded in the external chip converts power source into a voltage required by a chip circuit.

A variable constant voltage generator 460 embedded in a chip or a system provides a variable constant voltage or a fixed output voltage to a memory 410, an input/output interface 420, a CPU 430, and system logic 440 of the chip or the system.

An embodiment of the present invention must be realized within the allowable variable range that does not interfere with accurate data processing. Also, the ranges of a variable reference voltage and a variable output voltage and object modules of the chip or the system must be determined within the allowable variable scope. As a result, hacking caused by a data execution command and data execution processing can be prevented from a power waveform measured by an external input voltage unit 450 of the chip or the system, thereby reducing the system power.

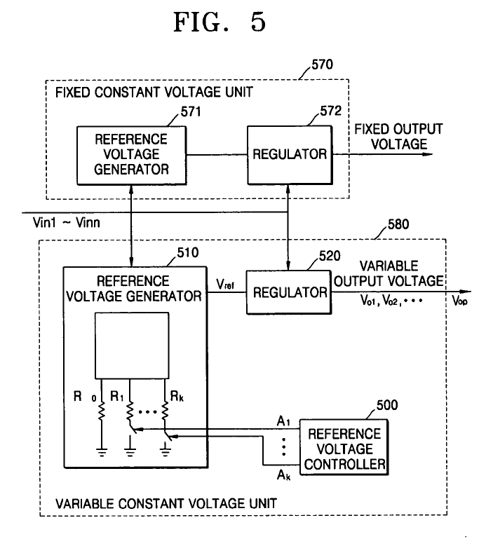

FIG. 5 is a perspective view of a variable constant voltage generator 580 connected to a fixed constant voltage generator 570. Referring to FIG. 5, the fixed constant voltage generator 570 comprises a reference voltage generator 571 and a regulator 572. The reference voltage generator 571 and the regulator 572 correspond to the reference voltage generator 210 and the regulator 220 illustrated in FIG. 2 but do not change a reference voltage through resistance switching. Instead, the fixed constant voltage generator 570 generates a single constant voltage.

The variable constant voltage generator 580 comprises a reference voltage controller 500, a reference voltage generator 510, and a regulator 520, which correspond to and perform the same functions as the reference voltage controller 200, the reference voltage generator 210, and the regulator 220, respectively, illustrated in FIG. 2.

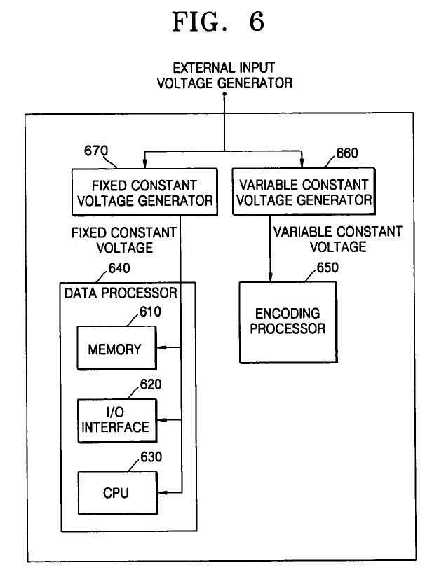

FIG. 6 is a block diagram of a chip or a system including a fixed constant voltage generator 670 and a variable constant voltage generator 660.

A fixed constant voltage is applied to components performing a data execution command or a user execution command where hacking does not occur to provide a stable system power source, or a stable system power source and accurate data processing, and a variable constant voltage is applied to components in which password is used or critical data processing is performed and to prevent hacking.

In detail, a single constant voltage is applied by the fixed constant voltage generator 670 to a data processor 640 such as a memory 610, input/output interface 620, CPU 630, etc. that precisely processes data and requires a stable system power source.

Here, the data processor 640 does not require a high level of security, and thus the single constant voltage is applied to the fixed constant voltage generator 670 even if the data execution command or the user command is understood from the consumption power waveform, thereby accurately processing data.

On the other hand, a variable constant voltage is applied by the variable constant voltage generator 660 to an encoding processor 650 such as a security chip, a smart card, etc. that processes encoding, thereby producing a random or constant waveform for the power consumption, which prevents an attacker from hacking by means of the waveform for the power consumption.

According to another embodiment of the present invention, a ubiquitous system manages optimum power using a low-power active RFID, a sensor board, a system board, a system on chip (SoC), etc.

The variable constant voltage generator 660 generates a reference constant voltage Vref to supply reference power for operating at a usual signal processing speed. The variable constant voltage generator 660 also generates a reference constant voltage Vrefh greater than the reference constant voltage Vref to supply more power than the reference power when fast signal processing is required or a high performance function is performed. The variable constant voltage generator 660 generates a lower reference constant voltage Vrefh than the reference constant voltage Vref to supply less power than the reference power when low signal processing is required or the system stops operating. Therefore, an optimum power management system is provided. The optimum power management increases the efficiency of the system and extends the lifetime of a battery of the system.

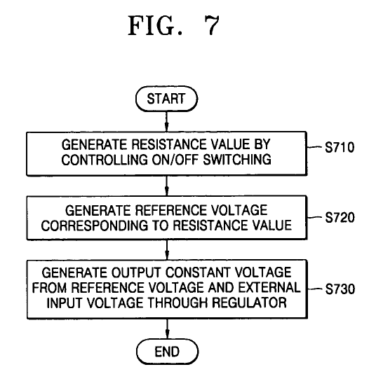

FIG. 7 is a flowchart of a method of generating a variable constant voltage according to an embodiment of the present invention. Referring to FIG. 7, on/off switches connected to the end of N resistors are controlled according to digital signals having a value 1 or 0 generated by the reference voltage controllers 100 and 200 and a resistance value Rd is generated (Operation S710).

The variable reference voltage generator 110 and 210 generate a reference voltage Vref corresponding to the resistance value Rd. The reference voltage Vref is changed into a plurality of reference constant voltage values according to changes in the resistance value Rd by the on/off switches controlled by the reference voltage controllers 100 and 200 (Operation S720).

The reference voltage Vref generated by the variable reference voltage generator 110 and 210 and an external input voltage Vin are used to generate a constant voltage Vout through the regulator 120 comprising the error amplifier 121, the passing device 122, and the sampling device 123 (Operation S730).

The generation of the resistance value Rd can be based on random digital signals generated by a hardware-based random number generator or an irregular signal device.

The generation of the resistance value Rd can include the generation of a digital signal to produce a constant waveform in which the maximum and minimum amplitudes of system power consumption measured by an external input voltage terminal 150 are constant.

The generation of the resistance value Rd can include the generation of a digital signal that controls the on/off switches connected to the ends of N resistors in order to generate the reference constant voltage Vref for supplying reference power for a usual signal processing speed.

When fast signal processing is required or a high performance function is performed, the generation of the resistance value Rd further includes generating a digital signal for controlling the on/off switches such that a reference constant voltage Vrefh higher than the reference constant voltage Vref to supply more power than the reference power.

When low signal processing is required or the system stops operating, the generation of the resistance value Rd further includes the switching controlling the on/off switches to a lower reference constant voltage Vrefl than the reference constant voltage Vref to supply less power than the reference power.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed network coupled computer systems so that the computer readable code is stored and executed in a distributed fashion.

The apparatus and method for generating a variable constant voltage according to the present invention generates a plurality of constant voltages by controlling on/off switching, measuring a power consumption waveform, and analyzing statistical data, thereby providing security protection against hacking through a power attack.

Also, the apparatus and method for generating a variable constant voltage according to the present invention generates a plurality of output constant voltages by changing a reference voltage according to system signal processing and system consumption power, so that a ubiquitous system can ensure a efficient computing power consumption using a low-power based active RFID, a sensor board, etc.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for generating a variable constant voltage, the apparatus comprising:
a reference voltage controller controlling on/off switches connected to ends of N resistors according to a digital signal value;
a variable reference voltage generator generating a reference voltage corresponding to a resistance value obtained by controlling the on/off switches; and
a regulator generating a constant voltage based on the reference voltage and an external input voltage.

2. The apparatus of claim 1, wherein the reference voltage controller generates the digital signal to produce a random or constant power consumption waveform and controls the on/off switches connected to ends of the N resistors according to the digital signal value.

3. The apparatus of claim 1, wherein the reference voltage controller controls the on/off switches connected to ends of the N resistors according to the digital signal value by generating a digital signal to produce a higher constant voltage than the reference constant voltage when system power consumption is greater than reference system power consumption and
generating a digital signal to produce a lower constant voltage than the reference constant voltage when the system power consumption is less than the reference system power consumption.

4. A method of generating a variable constant voltage, the method comprising:
generating a resistance value by controlling on/off switches connected to each end of N resistors according to a digital signal value;
generating a reference voltage corresponding to the resistance value; and
generating a constant voltage based on the reference voltage and an external input voltage.

5. The method of claim 4, wherein the generating of the resistance value comprises controlling the on/off switches connected to ends of the N resistors according to the digital signal value and generating the resistance value by generating a random digital signal or a constant digital signal to produce a constant power consumption waveform.

6. The method of claim 4, wherein the generating of the resistance value comprises generating a digital signal to produce a higher reference constant voltage than the reference constant voltage when system power consumption is greater than reference system power consumption and
generating a digital signal to produce a lower reference constant voltage than the reference constant voltage when the system power consumption is less than the reference system power consumption.

7. A system comprising:
a first data processor storing, calculating, and inputting/outputting data to produce a power consumption waveform corresponding to data processing for a stable system power source;
a second data processor encoding data to prevent the system against hacking;
a fixed constant voltage generator providing the first data processor with a fixed constant voltage; and
a variable constant voltage generator controlling on/off switches connected to ends of N resistors according to a digital signal value to produce a random or constant power consumption waveform, generating a reference voltage corresponding to the resistance value, generating a constant voltage based on the reference voltage and an external input voltage, and providing the constant voltage to the second data processor.
